(19) United States
(12) Patent Application Publication
(10) Pub. No.: US 2017/0006421 A1
(43) Pub. Date: Jan. 5, 2017

(54) Social Networking Interface

(71) Applicants: Sam Jerez, Cape Coral, FL (US); William E. Molina, Cape Coral, FL (US)

(72) Inventors: Sam Jerez, Cape Coral, FL (US); William E. Molina, Cape Coral, FL (US)

(21) Appl. No.: 14/580,282

(22) Filed: Dec. 23, 2014

(51) Int. Cl. H04W 4/02

(52) U.S. Cl. CPC H04W 4/023; H04L 67/306

(57) ABSTRACT

The present invention includes receiving at least one of a user entity preference, wherein said user preference is indexed, catalogued and stored with reference to a user entity; comparing the at least one user entity preference with a plurality of other user entity preferences which are indexed, catalogued, and stored with reference to at least one second user entity; and notifying and displaying to the user entity a shared at least one user entity preference with the at least one second user entity.

### CROSS-REFERENCE TO RELATED APPLICATION

This application claims reference to a previously filed Provisional Patent Application 61/921,200 filed Dec. 27, 2013, which is incorporated by reference herein.

### FIELD OF THE INVENTION

The present invention relates to a social networking interface that enables separate user entities to connect and coordinate effectively.

### BACKGROUND OF THE INVENTION

A social networking or media interface can act to provide a location and/or medium for entities to interact with one another. A typical networking or media interface can include a user searching out and directly communicating with other known users.

### SUMMARY OF THE INVENTION

It is, therefore, an object of the present invention to provide a social networking interface whereby a user entity can either actively or passively search for and find other compatible user entities, the compatibilities becoming known through a number of active or passive embodiments. It is another object of the present invention to provide a social networking interface network device, a system for using the network device, and non-transitory computer readable storage media containing computer-executable instructions which can enable the network device or any other computing device to engage in the social networking interface, once the instructions are installed on that device.

An exemplary environment for the present invention can include, but is not limited to, a communication network environment, combining local area networks, wide area networks, and wireless networks through the use of user entity devices, as well as any other environment in which network communication and the use of a social networking interface is desired. Mobile computing and communication devices are contemplated to be used in this environment, for example, including but not limited to, a mobile device “smartphone,” or wireless-enabled “tablet” computing device.

In an exemplary embodiment of the present invention, a network device can include a transceiver and a processor.

In an exemplary aspect of the present network device, the transceiver can send and receive data over a network.

In another exemplary aspect of the present network device, the processor can be operative on the received data to perform actions.

In a further exemplary aspect of the present network device, the processor can perform such actions, for example, as receiving at least one of a user entity preference.

In still yet another exemplary aspect of the present network device, the at least one user entity preference can be indexed, catalogued, and/or stored with reference to a user entity.

In another exemplary aspect of the present network device, the processor can perform further actions, such as, for example, comparing the at least one user entity preference with a plurality of at least one second user entity preferences which are indexed, catalogued and/or stored with reference to at least one second user entity.

In still another exemplary aspect of the present network device, the processor can perform further actions, such as, for example, notifying and/or displaying to the user entity a shared at least one user entity preference with the at least one second user entity.

The following are additional and/or exemplary aspects of the present network device, one or more of which can be combined with the basic network device and its elements, as embodied above:
A processor that is operative on received data and enabled to perform any and/or all of the following exemplary actions, or more of which can be combined with the basic network device embodied above, for example:
   evaluating a received at least one use entity preference to identify a user entity-defined selection for comparing the at least one user entity preference with the plurality of at least one second user entity preferences;
   receiving the at least one of a user entity preference further comprising receiving a geographical location marker for the user entity;
   comparing the at least one user entity preference with the plurality of at least one second user entity preferences further comprises comparing with the geographical location markers received from the at least one second user entity;
   notifying and displaying to the user entity a shared at least one user entity preference with the at least one second user entity further comprises notifying and displaying a geographical proximity of the at least one second user entity to the user entity;
   providing the user entity with one or more interface display screens usable to enable the user entity to select various user entity preferences, wherein selecting various use entity preferences further comprises the user entity:
      ranking an importance of the user entity preferences, wherein the importance rank factors into the comparison of user entity preferences with the plurality of the at least one second user entity preferences; and
      selecting a level of privacy accorded to each user entity preference, wherein the level of privacy determines whether or not the at least one second user entity received notification of the shared user entity preference; and
   notifying and displaying to the user entity a shared at least one user entity preference with the at least one second user entity further comprises connecting to a peripheral network accessory which displays and/or notifies to either and/or both the user entity and the at least one second user entity a visual and/or sensory notification of geographical proximity of the user entity and/or the at least one second user entity.

In an exemplary embodiment of the present invention, a system can include a one or more user entity devices and a network device.

In an exemplary aspect of the present network system, the network device further comprises a processor and the network device is configured, through the processor, to communicate with the one or more user entity devices over a network.

In a further exemplary aspect of the present system, network device is further configured to perform such actions, for example, as receiving by the network device from a first user entity device in the one or more user entity devices, at least one of a user entity preference. The at least one user entity preference can be indexed, cataloged, and/or stored with reference to a user entity.

In another exemplary aspect of the present system, the network device can be configured to perform further actions, such as, for example, comparing the at least one user entity preference with a plurality of at least one second user entity preferences which are indexed, catalogued and/or stored with reference to at least one second user entity.

In still another exemplary aspect of the present system, the network device can be configured to perform further actions, such as, for example, notifying and/or displaying to the user entity a shared at least one user entity preference with the at least one second user entity.

The following are additional and/or exemplary aspects of the present system, one or more of which can be combined with the basic system and its elements, as embodied above:
A network device further configured to perform any and/or all of the following exemplary actions, or more of which can be combined with the basic system embodied above, for example:
   evaluating a received at least one use entity preference to identify a user entity-defined selection for comparing the at least one user entity preference with the plurality of at least one second user entity preferences;
   receiving the at least one of a user entity preference further comprising receiving a geographical location marker for the user entity;
   comparing the at least one user entity preference with the plurality of at least one second user entity preferences further comprises comparing with the geographical location markers received from the at least one second user entity;
   notifying and displaying to the user entity a shared at least one user entity preference with the at least one second user entity further comprises notifying and displaying a geographical proximity of the at least one second user entity to the user entity;
   providing the user entity with one or more interface display screens usable to enable the user entity to select various user entity preferences, wherein selecting various use entity preferences further comprises the user entity:
      ranking an importance of the user entity preferences, wherein the importance rank factors into the comparison of user entity preferences with the plurality of the at least one second user entity preferences; and
      selecting a level of privacy accorded to each user entity preference, wherein the level of privacy determines whether or not the at least one second user entity received notification of the shared user entity preference; and
   notifying and displaying to the user entity a shared at least one user entity preference with the at least one second user entity further comprises connecting to a peripheral network accessory which displays and/or notifies to either and/or both the user entity and the at least one second user entity a visual and/or sensory notification of geographical proximity of the user entity and/or the at least one second user entity.

In another exemplary embodiment of the present invention, a non-transitory computer readable storage medium can include computer-executable instructions, the computer executable instructions when installed onto a computing device enable the computing device to perform actions.

In an exemplary aspect of the present computer-executable instructions, the computing device can be enabled to receive at least one of a user entity preference. The at least one user entity preference can be indexed, catalogued, and/or stored with reference to a user entity.

In another exemplary aspect of the present computer-executable instructions, the computing device can be further enabled to compare the at least one user entity preference with a plurality of at least one second user entity preferences which are indexed, catalogued and/or stored with reference to at least one second user entity.

In still another exemplary aspect of the present computer-executable instructions, the computing device can be further enabled to notify and/or display to the user entity a shared at least one user entity preference with the at least one second user entity.

The following are additional and/or exemplary aspects of the present computer-executable instructions, whereby the computing device can be further enabled to perform one or more of the following actions, alone or in combination with the basic system, the basic network device and its elements and the basic non-transitory computer readable storage medium, as embodied above:
evaluating a received at least one use entity preference to identify a user entity-defined selection for comparing the at least one user entity preference with the plurality of at least one second user entity preferences;
receiving the at least one of a user entity preference further comprising receiving a geographical location marker for the user entity;
comparing the at least one user entity preference with the plurality of at least one second user entity preferences further comprises comparing with the geographical location markers received from the at least one second user entity;
notifying and displaying to the user entity a shared at least one user entity preference with the at least one second user entity further comprises notifying and displaying a geographical proximity of the at least one second user entity to the user entity;
providing the user entity with one or more interface display screens usable to enable the user entity to select various user entity preferences, wherein selecting various use entity preferences further comprises the user entity:
   ranking an importance of the user entity preferences, wherein the importance rank factors into the comparison of user entity preferences with the plurality of the at least one second user entity preferences; and
   selecting a level of privacy accorded to each user entity preference, wherein the level of privacy determines whether or not the at least one second user entity received notification of the shared user entity preference; and
notifying and displaying to the user entity a shared at least one user entity preference with the at least one second user entity further comprises connecting to a peripheral network accessory which displays and/or notifies to either and/or both the user entity and the at least one second user entity a visual and/or sensory notification of geographical proximity of the user entity and/or the at least one second user entity.

In still yet another exemplary embodiment of the present invention, an exemplary system can comprise one or more user entity devices; and a peripheral network accessory device comprising a processor and configured to receive at least one data element from the one or more user entity devices over a network,

The exemplary peripheral network accessory device can perform at least the following actions: displaying to a user entity the at least one data element through a visual notification or an audio notification; wherein displaying occurs when the at least one data element is a similar at least one data element to an at least one data element of an at least one second user entity that is in a geographical proximity of the user entity.

These and other exemplary aspects of the present invention are described herein.

Those skilled in the art will recognize still other aspects of the present invention upon reading and understanding the attached description.

### BRIEF DESCRIPTION OF THE DRAWINGS

The present invention is illustrated by way of example, and not in limitation, in the figures of the accompanying drawings.

For a better understanding of the present invention and its embodiments, reference will be made to the following detailed description, which is to be read in association with the accompanying drawings.

FIG. 1 illustrates is a system diagram of one embodiments of a network environment in which the inventive concept can be practiced.

FIG. 2 illustrates one embodiment of a user entity device that can be included in a system implementing the inventive concept.

FIG. 3 illustrates one embodiment of a network device that can be included in a system implementing the inventive concept.

FIG. 4 illustrates a logical flow diagram generally showing one embodiment of a process for using the inventive concept.

FIG. 5 illustrates one embodiment of a user interface for selecting and ranking user entity preference and displaying such through a peripheral network entity device, as part of the inventive concept.

### DETAILED DESCRIPTION OF THE INVENTION

The present invention will now be described more fully herein after with reference to the accompanying drawings, which form a part hereof, and which show, by way of illustration, specific exemplary embodiments by which the invention may be practiced. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Among other things, the present invention may be embodied as methods or devices. Accordingly, various exemplary embodiments may take the form of an entirely hardware embodiments, an entirely software embodiment and/or an embodiment combining software and hardware aspects. The following detailed description, is, therefore, not to be taken in a limiting sense.

Throughout the specification and claims, the following terms take the meanings explicitly associated herein, unless the context clearly otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope, its purpose is merely to present some concepts in a simplified form as a prelude to the more detailed description that is presented later.

The present invention, generally, is directed towards providing a social networking interface for users with both a passive and active platform to engage in social identification with other users. Such application is directed towards providing an opportunity for a user to create an online identity, including many factors such as personal preferences in relationship, hobbies, religion, geographic location, professional services, classified ads looking for specific things, etc., and, and having this online identity compared through a database indexing and cataloguing feature with the online identities of any number of other users. Though the comparisons occur continuously, the user has the opportunity to be periodically notified of similarities to other users and given the opportunity, at the user's discretion, to connect with said users.

A social networking interface, generally, is a platform used to build social relations or social networks among individuals, who, for example, share interests, activities, backgrounds, or real-life connections. A social networking interface consists of a representation of a user, the user's social and/or professional links, and a variety of additional information, for example, likes, preferences and services. Commonly, social networking interfaces are web-based and provide a platform for users to actively interact over the Internet. Social networking interfaces also commonly allow users to share ideas, pictures, posts, activities, videos, other digital media, events and interests with people are known to them, and are, for example, in the user's network of connections.

A common type of social networking services are those that contain category places (for example, school year or classmates), a platform to connect with existing friends, and a recommendation system linked in trust. Many early social networking communities focused on bringing people together to actively interact with each other through chat rooms, and actively encouraged people to share personal information and ideas via personal webpages by providing easy-to-use tool and free and/or inexpensive webpage. However, the ability to find and/or manage connections and relationships based on commonality remain difficult.

Web-based social networking services make it possible to actively connect people who share interests and activities across political, economic, and geographic borders. However, privacy concerns with web-based social networking services have arisen, because of the danger of having too much personal information available through the web. In addition, there is a perceived privacy threat in relation to placing too much personal information in the hands of large corporations or governmental bodies, allowing a user profile to be passively produced (i.e., without the active participation of the user but instead by collection of found information by a third party), on an individual's behavior on which decisions, detrimental or beneficial to the individual, may be taken.

Furthermore, there is an issue over the control of date. Information that has been altered and/or removed by a user may in fact be retained by a web-based service and passed on to third parties. Privacy may be undermined by many factors, such as, for example, a web-site not taking adequate steps to protect user privacy, not giving the user the opportunity to determine their own privacy settings, and third parties actively using information posted in a social networking site for other than connection purposes.

There are a growing number of web-based social network users who have decided to quit their user identities by committing what is known commonly as virtual identity suicide or Web 2.0 suicide. Reasons for this include, for example, privacy concerns, being followed by a general dissatisfaction with the social networking website, negative aspects regarding existing social network friends and the feeling of getting addicted to the social networking website.

The social networking interface provided for in the present invention, allows great user interface with what are considered preferences, communication and/or privacy availability methods, and how much availability to the user's information exists.

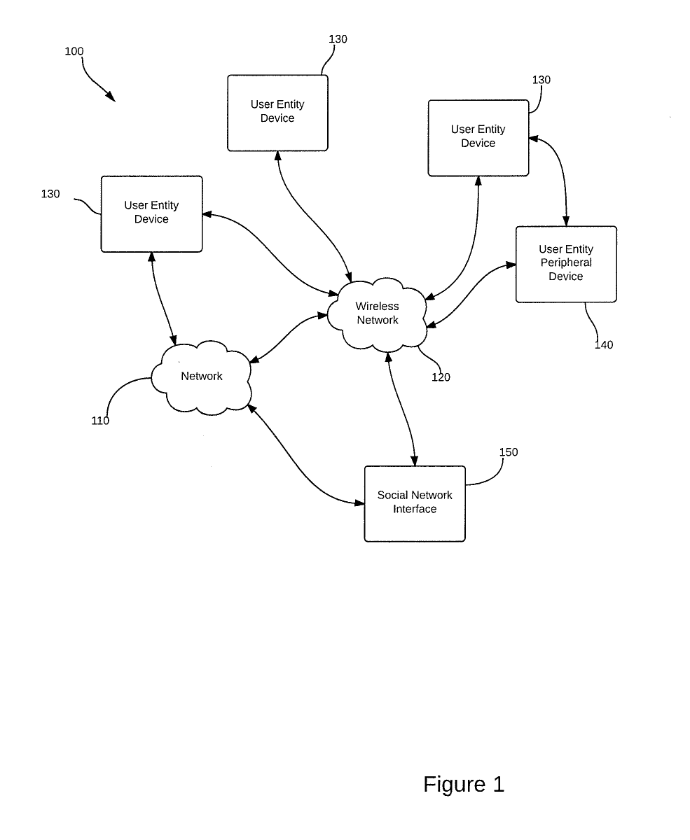

FIG. 1 illustrates one embodiments of an environment in which the inventive social networking interface may be practiced. Not all the components may be required to practice the invention, and variations in the arrangement and type of the components may be made without departing from the spirit or scope of the invention. As shown in FIG. 1, system 100 includes network 110, wireless network 120, user entity devices 130, user entity peripheral devices 140 and the social networking interface 150.

Network 110 can be configured to couple user devices 130 and user entity peripheral devices 140 with other computing devices, including the social networking interface 150, directly to user entity devices 130, directly user entity peripherals 140, to and through wireless network 120 to user entity devices 130 and through wireless network 120 to user entity peripherals 140. Network 110 can be enabled to employ any form of computer readable media for communicating information from one electronic device to another. Also, network 110 can include the Internet in addition to local area networks (LANs) and wide area networks (WANs), direct connections, such as, for example, through a universal serial bus (USB) port, other forms of computer-readable media, or any combination thereof. On an interconnected set of LANs, including those based on differing architectures and protocols, a router acts as a link between LANs, enabling data communication to be sent from one to another. In addition, data communication links within LANs typically include twisted wire pair or coaxial cable, while data communication links between networks may utilize analog telephone lines, full or fractional dedicated digital lines including T1, T2, T3 and T4, Integrated Services Digital Networks (ISDNs), Digital Subscriber Lines (DSLs), wireless links including, but not limited to satellite links, or other communications links known to those skill in the art. Furthermore, remote computers and other related electronic devices could be remotely connected to either LANs or WANs via a modem and temporary telephone link In essence, network 110 includes any communication method by which information may travel between computing devices.

Wireless network 120 can be configured to couple user entity devices 130 and their components with network 110. Wireless network 120 can included any of a variety of wireless sub-networks that may future overall stand-alone ad-hoc networks, and the like, to provide an infrastructure-oriented connection for user entity devices 130. Such sub-networks may include mesh networks, wireless LAN (WLAN) networks, cellular networks, and any other format of wireless connection.

Wireless network 120 can further include an autonomous system of terminals, gateways, routers, and the like connected by wireless radio links, and similar. These connectors can be configured to move freely and randomly and organize themselves arbitrarily, such that the topology of wireless network 120 may change rapidly.

Wireless network 120 may further employ a plurality of access technologies including second (2G), third (3G) generation radio access for cellular systems, Code Division Multiple Access (CDMA), WLAN, Wireless Router (WR) mesh, and similar configurations. Access technologies such as 2G, 3G and future access network may enable wide area coverage for mobile devices, such as embodiments of user entity devices 130, with various degrees of mobility. For example, wireless network 120 may enable a radio connection through a radio network access such as Global System for Mobil Communication (GSM), General Packet Radio Services (GPRS), Enhanced Data GSM Environment (EDGE), Wideband Code Division Multiple Access (WCDMA), and similar. In essence, wireless network 120 may include virtually any wireless communication mechanism by which information may travel between user entity devices 130 and another computing device, network or similar.

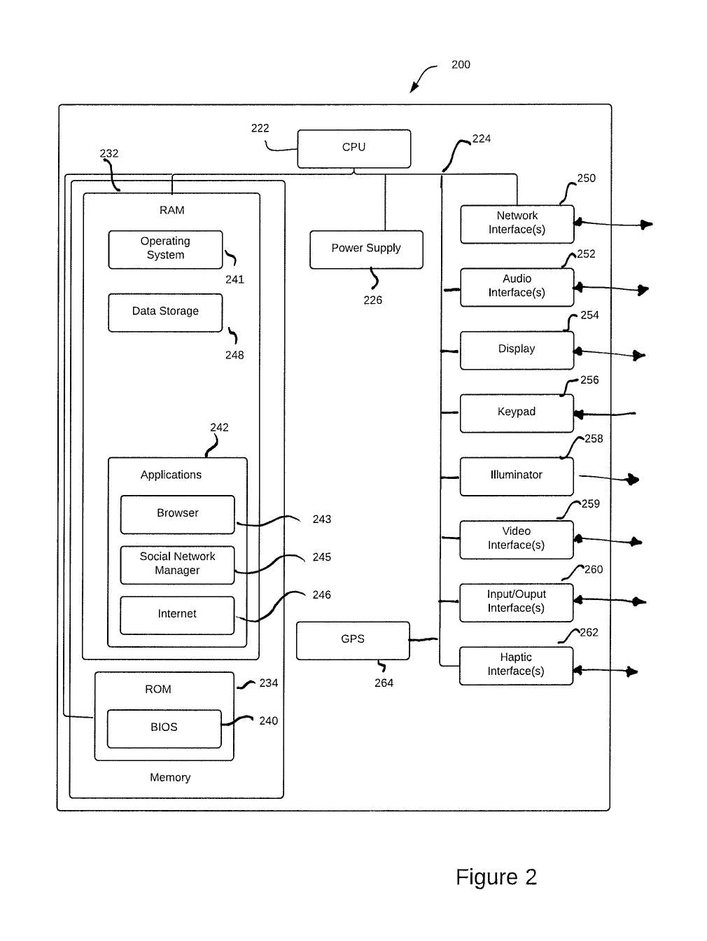

One embodiment of a user entity device 130 is described in more detail below in conjunction with FIG. 2. Generally, however, user entity devices 130 may include virtually any portable computing device capable of receiving and sending data over a network, such as network 110 and wireless network 120. User entity devices 130 may also be described generally as a user entity user device that is configured to be portable. Thus, user entity devices 130 may include virtually any portable computing device capable of connecting to another computing device and receiving information. Such devices include portable devices, for example, mobile phones, smartphones, display pages, Radio Frequency (RF) devices, Infrared (IR) devices, Near Frequency Communication (NFC) devices, Personal Digital Assistants (PDAs), handheld computers, tablets, laptop computers, wearable computers, computer peripheral accessories, integrated devices combining one or more of the preceding devices, and the like. As such, user entity devices 130 typically range widely in terms of capabilities and features. For example, a mobile phone may have a numeric keypad and a few lines of monochromatic LCD display on which only text may be displayed. In another example, a web-enabled mobile device such as a tablet may have a touch sensitive screen, a stylus and several lines of color LCD display in which both text and graphics can be displayed.

User entity devices 130 may include virtually any computing device capable of communicating over a network to send and receive information, including communicating social networking information, performing various online activities, including trading data with other user entity devices, and similar. The set of such devices that can be used for user entity devices 130 include devices that typically connect using wired or wireless communications mediums, such as, for example, personal computers, multiprocessor systems, microprocessor-based or programmable consumer electronics, network PCs, and the like. In one embodiment, at least some of the user entity devices 130 can operate over wired and/or wireless networks. User entity devices 130 can also include virtually device usable as a television device, as many newer models of these devices include a capability to access and/or otherwise communicate over a network such as network 110 and/or wireless network 120. Moreover, user entity devices 130 may access various computing applications, including a browser, social networking interface, and/or any other web-based application.

A web-enabled user entity device 130 may include a browser application that is configured to receive and to send web pages, web-based communications, and any other data. The browser application can be configured to receive and display graphics, text, multimedia, and similar functionalities, employing virtually any web-based language, including, but not limited to, a wireless application protocol (WAP) and similar. In one embodiment, the browser application can be enabled to employ Handheld Device Markup Language (HDML), Wireless Markup Language (WML), WML-Script, JavaScript, Standard Generalized Markup Language (SMGL), HyperText Markup Language (HTML), eXtensble Markup Language (XML) and any other programming language that is functionally compatible, to display and send information. In one embodiment, a user of the user entity device 130 can employ the browser to perform various activities over a network, however, another application besides the browser can also be used to perform various online activities.

User entity devices 130 can also include at least one other user entity application that is configured to send and receive content from and to another computing device. The user entity application can include a capability to provide and receive textual content, graphical content, audio content, and any other type of transmittable information. The user entity application can further provide information that identifies itself, including, but not limited to, a type capability, name and any other functionally necessary descriptive information. In one embodiment, user entity devices 130 can uniquely identify themselves through any of a variety of mechanisms, for example, including but not limited to, a phone number, Mobile Identification Number (MIN), an Electronic Serial Number (ESN), a Global Positioning System (GPS) identifies, or other mobile device identifier. In additional embodiments, the information can also indicate a content format that the mobile device is enabled to employ. For example, such information can be provided in a network packet, or any other data transmission format, sent the social networking interface 150, or any other interface. Such end-user account, for example, can be configured to enable the end-user to manage one or more online activities, including, for example, but not limited to, search activities, browsing of various websites, making purchases, selling products/services, communicating with others and otherwise engaging in online activities. However, participation in such online activities can also be performed without logging into an end-user account.

User entity peripheral devices 140 may include virtually any computing and/or receiving device capable of receiving communicating over a network, including receiving social networking information, performing various online activities, including receiving data from other user entity devices, user entity peripherals and similar. The set of such devices that can be used for user entity peripheral devices 140 include devices that typically connect using a wired or wireless communications mediums, such as, for example, microprocessor-based or programmable consumer electronics, and the like. In one embodiment, at least some of the user entity peripheral devices 140 can operate over wired and/or wireless networks. These devices can include, for example, but are not limited to, mobile phones, smartphones, display pagers, Radio Frequency (RF) devices, Infrared (IR) devices, Near Frequency Communication (NFC) devices, Personal Digital Assistants (PDAs), handheld computers, tablets, laptop computers, wearable computers, general computer peripheral accessories, integrated devices combining one or more of the preceding devices, and the like. User entity peripheral devices 140 can also include virtually device usable as a television device, as many newer models of these devices include a capability to access and/or otherwise communicate over a network such as network 110 and/or wireless network 120. Communications to these devices can occur using networks and/or methods as described above.

Communication media typically embodies computer-readable instructions, data structures, program modules, or other transport mechanism and includes any information delivery media. By way of example, and not in limitation, communication media can include wired media such as twisted pair, coaxial cable, fiber optics, wave guides, and other wired media and wireless media such as acoustic, Radio Frequency (RF), Near Frequency Communication (NFC), infrared, and other wireless media.

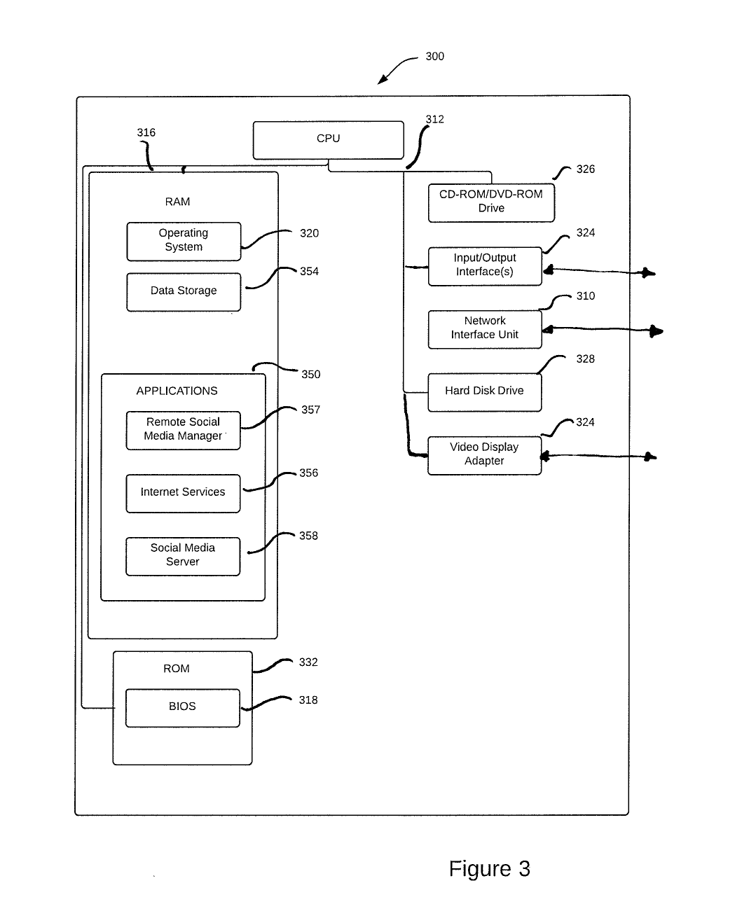

One embodiment of social networking interface 150 is described in more detail below in conjunction with FIG. 3. Briefly, social networking interface 150 may include any one or more computing devices capable of connecting to network 110 to enable user entity devices 130 to communicate between each other. In one embodiment, social networking interface 150 can further enable one or more users of user entity devices 130 to access and/or download a social networking interface application for use on the user entity devices 130. In one embodiment, the social networking interface application is configured to enable a user entity to provide various user preferences and settings. When configured, social networking interface 150 may then employ one or use of the user preferences to index and catalogue the user preference in reference to a specific user entity. In one embodiment, the data collected for indexing and cataloguing can be stored on user entity devices 130, however, in another embodiment, the data may be stored at least in part on social networking interface 150.

FIG. 2 shows one embodiment of user entity device 200 that may be used in a system implementing the invention. User entity device may include many more or less components than those shown in FIG. 2. However, the components shown are sufficient to disclose an illustrative embodiment for practicing the invention.

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-105 of FIG. 1.

As shown in FIG. 2, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internetprotocol (TCP/IP), SMS, general packet radio service (GPRS), WAP, ultra wide band (UEB), IEEE 8022.16 Worldwide Interoperability for Microwave Access (WiMax), SIP/RTP, or any of a variety of other wireless communication protocols,

Network interface 250 is sometimes known as a transceiver, transceiving device, or network interface card (NIC).

Audio interface 252 is arranged to produce and receive audio signals such as sound of a human voice. For example, audio interface 252 may be coupled to a speaker and microphone (not shown) to enable telecommunication with other and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may remain provide a status indication and/or provide light. Illuminator 258 may remain active for specific periods of time or in response to events. For example, when illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAT, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates an example of computer readable storage media (devices) for storage of information such as computer readable instructions, data structures, program nodules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with Java virtual machine module that enables control of hardware components and/or operating systems operations via Java application programs.

Memory 230 further includes one or more data storage 248, which can be utilized by client device 200 to store, among other things, applications 242 and/or other data. For example, data storage 248 may also be employed to store information that describes various capabilities of client device 200. The information may then be provided to another device based on any of a variety of events, including being sent as part of a header during a communication, sent upon request, or the like. Data storage 248 may also be employed to store social networking information including address books, buddy lists, aliases, user profile information, or the like. Further, as illustrated, data storage 248 may also store information about social networking user entity profiles, data collected from one or more user entities, including messages, videos, content post, duration (time) data, message count data, geographic data, or the like. At least a portion of the information may be stored on a disk drive or other computer-readable storage device (not shown) within client device 200.

Applications 242 may include computer executable instructions which, when executed by client device 200, transmit, receive, and/or otherwise process data (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications 242 may include, for example, browser 243, and social network manager 245, and a general internet application 246.

Browser 243 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperTest Markup Language (HTML), eXtensible Markup Language (XML), and the like, to display and send a message. However, any of a variety of other web-based languages may be employed.

In one embodiment, browser 235 may be configured to enable access to a graphical user interface provided by the Social Network Interface 150 of FIG. 1 and/or social network manager 245. In one embodiment, the user interface may be employed by a user of client device 200 to review and/or manage user preferences, and/or other aspects of social networking.

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may represent, for example, Social Network Interface 150 of FIG. 1.

Network device 300 includes processing unit 312, video display adapter 314, and a mass memory, all in communication with each other via bus 322. This mass memory generally includes RAM 316, ROM 302, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 can also communicate with the Internet, or some other communication protocols including the TCP/IP protocol. Network interface unit 310 is sometimes known as a transceiver, transceiving device, or network interface card (NIC).

The mass memory as described above illustrates another type of computer-readable storage devices, namely computer-readable storage media or devices. Computer-readable storage media may include volatile, nonvolatile, removable, and non-removable devices implemented in any method or technology for storage of information, such as computer readable instructions, data structures, program modules, or other data. Examples of computer readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

As shown, data stores 354 may include a database, text, spreadsheet, folder file, or the like, that may be configured to maintain and store user account identifiers, user profiles, email addresses, IM addresses, and/or other network addresses; or the like. Data stores 354 may also store various social networking content, and/or information about the social networking communication, including, but not limited to content and message sender and receiver information, duration of user sessions, a quantity of content indexed and catalogued between users, and/or data obtained from conducting a content analysis on one or more messages' content. In on embodiment, storage of such information may be based on a specific user, user account, profile, or the like. Thus, in one embodiment, storage of the information may be configured to provide at least some security and/or privacy constraints on the information. Data stores 354 may further include program code, data, algorithms, and the like, for use by a processor, such as central processing unit (CPU) 312 to execute and perform actions. In one embodiment, at least some of data store 354 might also be stored on another component of network device 300, including, but not limited to cd-rom/dvd rom 326, hard disk drive 328, or the like.

The mass memory also stores program code and data. One or more applications 350 are loaded into mass memory and run on operating system 320. Examples of application programs may include transcoders, schedulers, calendars, data-base programs, word processing programs, HTTP programs, customizable user interface programs, IPSec applications, encryption programs, security programs, SMS message servers, IM message servers, email servers, account managers, and so forth. Remote Social Media Manager 357, Internet services 356, and Social Media Server 358, may also be included as application programs within applications 350.

Social Media Server 358 represent any of a variety of services that are configured to provide content, including messages, over a network to another computing device. Thus, Social Media Server 358 includes for example, a web server, a File Transfer Protocol (FTP) server, a database server, a content server, or the like. Social Media Server 358 may provide the content including messages over the network using any of a variety of formats, including, but not limited to WAP, HDML, WML, SMGL, HTML, XML, cHTML, XHTML, or the like.

Internet server 356 may include virtually any computing component or components configured and arranged to forward messages and content from content and message user agents, and/or other content and message servers, or to deliver content messages to a local content and message store, such as data store 354, or the like. Thus, Internet server 356 may include a content and message transfer manager to communicate a message employing any of a variety of email protocols, including, but not limited, to Simple Mail Transfer Protocol (SMTP), Post Office Protocol (POP), Internet Message Access Protocol (IMAP), MNTP, or the like. Internet server 356 may also be managed by one or more components of Internet server 356. Thus, Internet server 356 may also be configured to manage SMS messages, IM, MMS, IRC, RSS feeds, mIRC, or any of a variety of other message types. In one embodiment, Internet server 356 may enable users to initiate and/or otherwise conduct chat sessions, VOIP sessions, or the like.

In one embodiment, Remote Social Media Manager 357 is configured to provide a downloadable component, such as Social Network Manager 245 of FIG. 2 to a client device for use in managing likeness user preferences, and/or managing of likeness displays, and/or the like. In one embodiment, Remote Social Media Manager 357 might operate independent of a local Social Network Manager of a client device. That is, in one embodiment, a client device might be configured to interact with social media server 358 and/or internet services 356, which in turn interact with Remote Social Media Manager 357 to provide social networking actions to a client device.

In one embodiment, as noted elsewhere, Remote Social Media Manager 357 provides user interfaces for display at a client device that enables a user to manage various user preferences. For example, in one embodiment, a user might specify one or more users from their contact lists, or the like, for which the user requests likeness percent data to be provided to the user. Remote Social Media Manager 357 may then monitor various content and messaging activities between the user and one or more other user to determine various data, including, a duration of each messaging session; a count of messages; and/or even various POS analysis data. In one embodiment, such data may be obtained based on communications between a first user and one or more other users, and based on communications between the other users and not with the first user entity.

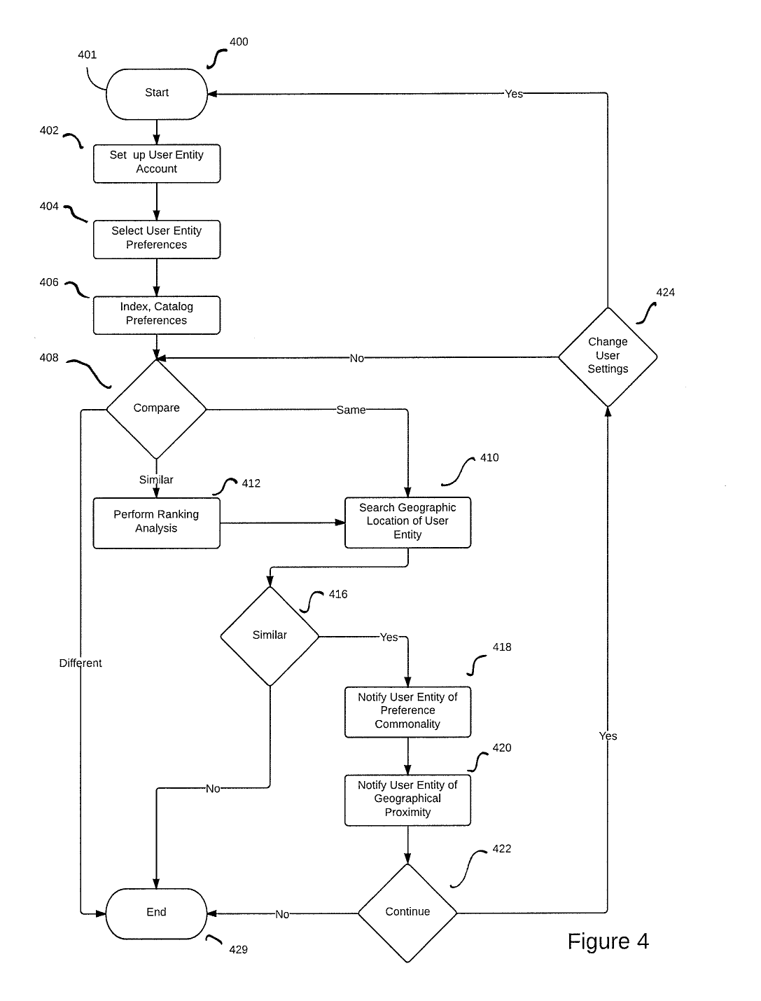

The operation of certain aspects of the invention will now be described with respect to FIG. 4. FIG. 4 illustrates a logical flow diagram generally showing one embodiment of a process for using the social networking interface through the devices and systems described above. As noted elsewhere, process 400 of FIG. 4 can be implemented in part, or whole, within network device 300 of FIG. 3, and/or one or more of the user entity devices 200 of FIG. 2. Furthermore, it is contemplated that steps be added and/or removed from Process 400. The following detailed description is, therefore, not to be taken in a limiting sense, and various embodiments envisioned by adding and/or removing steps in the process may be readily combined, without departing from the scope or spirit of the invention.

Process 400 begins after a start block 401, at 402, where a user entity sets up a user entity identity and/or account. An online identity, internet identity, or internet persona is a social identity that an Internet user establishes in online communities and websites. It can also be considered as an actively constructed presentation of oneself. Although some users prefer to use real names online, some Internet users prefer to be anonymous, identifying themselves by means of pseudonyms, which reveal varying amounts of personally identifiable information. An online identity may even be determined by a user's relationship to a certain social group they are a part of online Some can even be deceptive about their identity. A user entity as contemplated for use with the current inventive concept include, but are not limited to, a human person, a digital avatar created by a human person, an computer-generated or artificial intelligence entity, a business entity operated by a human and/or a computer user entity, an animal operating alone and/or operating with the assistance of a human and/or computer entity, and the like.

In some online contexts, including Internet forums, online chats, and massively multiplayer online role-playing games (MMORPGs), users can represent themselves visually by choosing an avatar, an icon-sized graphic image. Avatars are one way users express their online identity. As other users interact with an established online identity, it acquires a reputation, which enables them to decide whether the identity is worthy of trust. Some websites also use the user's IP address to track their online identities using methods such as tracking cookies.

The concept of the personal self, and how this is influenced by emerging technologies, are a subject of research in fields such as psychology and sociology. The online disinhibtion effect is a notable example, referring to a concept of unwise and uninhibited behavior on the Internet, arising as a result of anonymity and audience gratification. Process 400, when used as part of the inventive concept, allows a user to step outside social media settings which promote disinhibtion by allowing a user entity to determine visibility settings (described in more detail below) as associated with their user entity account.

At 402, a user entity has the option of creating a user account according to many methods and embodiments. For example, upon downloading an application to a mobile device, the user entity can be prompted to create a user account, update an existing using account, and/or bypass a user account and accessing the application contents as a guest. Additional embodiments include the option for a user entity to use a laptop computer or desktop computing device to log onto a website using a browser application, and thereby creating an account through a similar method however different the interface content and/or request methods are. Additional methods and embodiments envisioning a user entity creating and/or changing, editing and/or otherwise managing a user account are also contemplated.

At 404, a user entity selects at least one user entity preference, to include with their user entity account and/or online identity. User entity preferences are the user options for predilections of choice interests, including, for example but not limited to, hobbies, browsing, editing, searching, notifications, and similar. In one embodiment, along with preferences, professional, commercial, and/or personal services can be included as a preference setting, including a business listing and a list of a user entity's contributions are available. In additional embodiments contemplated, user entity preferences may include a number of feature settings, for example, relationship status, singled married, divorced, long-term relationship, friendship, casual encounters, sexuality such as gay, lesbian, bisexual, other, hobbies, such as sports, fitness, travel, religion, classified (looking for something specific) and custom preferences which are functionally compatible with the desired outcome of the user entity.

At 404, a user entity has the option to rank the user entity preferences according to a number of contemplated methods. These methods can include, but are not limited to, a user-defined method of rank, wherein the user manually determines the rank without input from a the social networking services; a services-assisted method wherein a user entity is recommended a rank based on similarly situated user entities; a random ranking method, or any other functionally necessary ranking method.

Privacy-publicity settings are also determined at 404. Privacy settings can include the option to have a user preference hidden for all search capabilities, for later use or for the personal reference of the user entity. Publicity settings can include the option for all user entity preferences to be searchable at all times, or searchable only during specified periods of times, or as with the privacy settings, not searchable at any time. Additional methods and embodiments illustrating privacy-publicity determinations and options for user also contemplated.

At 406, the indicated user entity preferences are indexed and catalogued, to be stored as part of the user entity account and/or user identity. In one exemplary embodiment field where indexing is a necessary component of calculating algorithms, for example, computer science, term indexing can be defined as the task of creating an index of terms and clauses into a collection. In one example, many operations in automatic theorem provers require search in huge collections of terms and clauses. Such operations typically fall into the following exemplary scheme: Given a collection S a of terms (clauses) and a query term (clause) q, find in S some/all terms t related to q according to a certain retrieval condition. Most interesting retrieval conditions are formulated as existence of a substitution that relates in a special way the query and the retrieved objects t. Here is a list of retrieval conditions frequently used in provers: term q is unifiable with term t, i.e., there exists a substitution θ, such that qθ=tθ; term t is an instance of q, i.e., there exists a substitution θ, such that qθ=t; term t is a generalization of q, i.e., there exists a substitution θ, such that q=tθ; clause q subsumes clause t, i.e., there exists a substitution θ, such that qθ is a subset/submultiset of t; and clause q is subsumed by t, i.e., there exists a substitution θ, such that tθ is a subset/submultiset of q.

Very often the sizes of term sets to be searched are large, the retrieval calls are frequent and the retrieval condition test is rather complex. In such situations linear search in S, when the retrieval condition is tested on every term from S, becomes prohibitively costly. To overcome this problem, special data structures, called indexes, are designed in order to support fast retrieval. Such data structures, together with the accompanying algorithms for index maintenance and retrieval, are called term indexing techniques.

Classic indexing techniques can include discrimination trees, substitution trees, and path indexing. Modern indexing techniques can include feature vector indexing, code trees, context trees, and relational path indexing.

In path indexing, a term is stored via the set of paths from the root to the leaves. In discrimination tree indexing, a term is stored via a single path representing a fixed-order traversal of the term. Discrimination trees provide faster lookup for many operations and in particular when looking for database terms which can be instantiated to the query term (which is relevant for subsumption). On the other hand, finding terms unifiable with a query term is more complicated since we need to skip and identify subterms in the index.

Relational path indexing, on the other hand, is an extension of the positional indexing. Its functionality is related to quick check: extract a vector of types (of feature values) from a mother (that will become and edge) and from a daughter, and test the unification of the two vectors before attempting to unify the edge and the daughter.

Path indexing differs from quick-check in two major aspects. First, quick check needs statistical training to decide from which nodes to extract the quick check vectors. Path indexing identifies these nodes by a static analysis of grammar rules, performed off-line and with no training required. Second, path indexing is built on top of positional indexing, therefore the vector of nodes used as a pre-test for unification can be different for each pair of mother-daughter that can unify.

The positional indexing has the benefit of allowing for a simple, yet efficient, implementation. Since each daughter is allocated a separate entry in the chart, further information collected about the peculiarities of each mother-daughter pair (with respect to the unification of the respective mother and daughter) can be integrated into the indexing scheme. This is one of the fundamental differences between indexing and filtering, and another reason for preferring indexing over filtering.

Feature vector indexing restricts the selection of features used in an index, a technique which has the option to immediately adapt to indexing modulo arbitrary AC theories with only minor loss of efficiency. Alternatively, in another exemplary example, the feature selection can be restricted to result in set subsumption. Feature vector indexing has been implemented in our equational theorem prover E, and has enabled us to integrate new simplification techniques making heavy use of subsumption. We experimentally compare the performance of the prover for a number of strategies using feature vector indexing and conventional sequential subsumption.

In pattern recognition and machine learning, a feature vector is an n-dimensional vector of numerical features that represent some object. Many algorithms in machine learning require a numerical representation of objects, since such representations facilitate processing and statistical analysis. When representing images, the feature values might correspond to the pixels of an image, when representing texts perhaps to term occurrence frequencies. Feature vectors are equivalent to the vectors of explanatory variables used in statistical procedures such as linear regression. Feature vectors are often combined with weights using a dot product in order to construct a linear predictor function that is used to determine a score for making a prediction. The vector space associated with these vectors is often called the feature space. In order to reduce the dimensionality of the feature space, a number of dimensionality reduction techniques can be employed. Exemplary embodiments of exemplifying feature vector and pattern recognition are also contemplated

Code trees are a certain category of variable length codes which can be represented by root trees. The structure of the tree defines the coding of the symbols regarded. Code trees consist of interior nodes, leaf nodes and corresponding branches. Leaf nodes do not have a succeeding node and represent symbols, if the tree describes a prefix code. The path from the root to a leaf node defines the code word for the particular symbol assigned to this node.

Normally common compression methods use binary code trees. In that case a left branch represents a binary 0 and a right branch a binary 1. A particular code word will be created by running from the root node to the symbol's leaf node. Any left-sided branch adds a 0 to the code word; every right-sided branch a binary 1. The required number of steps or the depth of this part of the code tree is equal to the code length.

Any node in a binary code tree has only one predecessor and two successors. If symbols are assigned only to leaf nodes and interior nodes only construct the tree, it is always sure that no code word could be the prefix of another code word. Such a tree matches the prefix property. Code trees can be constructed in a way that the probability for the occurrence of the symbols will be represented by the tree structure. Binary trees only allow a graduation of 1 bit. More precise solutions will be offered by the arithmetic code.

The context tree weighting method (CTW) is a lossless compression and prediction algorithm. The CTW algorithm is among the very few such algorithms that offer both theoretical guarantees and good practical performance. The CTW algorithm is an “ensemble method,” mixing the predictions of many underlying variable order Markov models, where each such model is constructed using zero-order conditional probability estimators. Additional embodiments and written description of various envisioned indexing methods can be found in also contemplated.

Cataloguing methods and standards involves the resolution of two potentially conflicting forces: provision of information for the ever-developing needs and interests of the scholarly (and, increasingly, the not-so-scholarly community), as reflected in the evolving methods employed in a variety of catalogues of other collections; and in-house styles, conventions, and methods, which cannot lightly be altered or abandoned.

Cataloging (or cataloguing) is the process of listing something for inclusion in a catalog. In library and information science, the process encompasses the production of bibliographial descriptions of books as well as other types of discovery tools for documents. Today cataloging study and practice has broadened and merged with that of metadata (“data about data contents”), increasingly associated with Resource Description and Access.

Cataloging rules have been defined to allow for consistent cataloging of various library materials across several persons of a cataloging team and across time. Users can use them to clarify how to find an entry and how to interpret the data in an entry. Cataloging rules prescribe which information about a bibliographic item is included in the entry and how this information is presented for the user; It may also aid to sort the entries in printing (parts of) the catalog.

In statistics, the multiple comparisons, multiplicity or multiple testing problem occurs when one considers a set of statistical inferences simultaneously or infers a subset of parameters selected based on the observed values. Errors in inference, including confidence intervals that fail to include their corresponding population parameters or hypothesis tests that incorrectly reject the null hypothesis are more likely to occur when one considers the set as a whole. Several statistical techniques have been developed to prevent this from happening, allowing significance levels for single and multiple comparisons to be directly compared. These techniques generally require a stronger level of evidence to be observed in order for an individual comparison to be deemed “significant”, so as to compensate for the number of inferences being made.

The term “comparisons” in multiple comparisons typically refers to comparisons of two groups, such as a treatment group and a control group. “Multiple comparisons” arise when a statistical analysis encompasses a number of formal comparisons, with the presumption that attention will focus on the strongest differences among all comparisons that are made. Techniques have been developed to control the false positive error rate associated with performing multiple statistical tests. Similarly, techniques have been developed to adjust confidence intervals so that the probability of at least one of the intervals not covering its target value is controlled.

For example, one might declare that a coin was biased if in 10 flips it landed heads at least 9 times. Indeed, if one assumes as a null hypothesis that the coin is fair, then the probability that a fair coin would come up heads at least 9 out of 10 times is (10+1)×(½)¹⁰=0.0107. This is relatively unlikely, and under statistical criteria such as p-value <0.05, one would declare that the null hypothesis should be rejected—i.e., the coin is unfair.

For hypothesis testing, the problem of multiple comparisons (also known as the multiple testing problem) results from the increase in type I error that occurs when statistical tests are used repeatedly. If n independent comparisons are performed, the experiment-wide significance level α̅, also termed FWER for familywise error rate, is given by α̅=1−(1−α_{{per comparison}})⁸. Hence, unless the tests are perfectly dependent, α̅ increases as the number of comparisons increases. If we do not assume that the comparisons are independent, then we can still say: α̅≦n·α_{{per comparison}}, which follows from Boole's inequality

Example: 0.2649=1−(1−0.05)⁵≦0.05×6=0.3.

There are different ways to assure that the familywise error rate is at most α̅. The most conservative, but free of independency and distribution assumptions method, is known as the Bonferroni correction α_{{per comparison}}=α̅/n. A more sensitive correction can be obtained by solving the equation for the familywise error rate of n independent comparisons for α_{{per comparison}}. This yields

$${α}_{\{ per comparsion \}} = 1 - {( 1 - \overline{α} )}^{\frac{1}{n}} ,$$

which is known as th\check{S}idàk correction. Another procedure is the Holm-Bonferroni method which uniformly delivers more power than the simple Bonferroni correction, by testing only the most extreme p value (i=1) against the strictest criterion, and the others (i>1) against progressively less strict criteria. α_{{per comparison}}=α̅/(n−i+1).

Multiple testing correction refers to re-calculating probabilities obtained from a statistical test which was repeated multiple times. In order to retain a prescribed familywise error rate α in an analysis involving more than one comparison, the error rate for each comparison must be more stringent than α. Boole's inequality implies that if each test is performed to have type I error rate α/n, the total error rate will not exceed α. This is called the Bonferroni correction, and is one of the most commonly used approaches for multiple comparisons.

In some situations, the Bonferroni correction is substantially conservative, i.e., the actual familywise error rate is much less than the prescribed level α. This occurs when the test statistics are highly dependent (in the extreme case where the tests are perfectly dependent, the familywise error rate with no multiple comparisons adjustment and the per-test error rates are identical). For example, in fMRI analysis, tests are done on over 100,000 voxels in the brain. The Bonferroni method would require p-values to be smaller than 0.05/100000 to declare significance. Since adjacent voxels tend to be highly correlated, this threshold is generally too stringent.

Because simple techniques such as the Bonferroni method can be too conservative, there has been a great deal of attention paid to developing better techniques, such that the overall rate of false positives can be maintained without inflating the rate of false negatives unnecessarily. Such methods can be divided into general categories: Methods where total alpha can be proved to never exceed 0.05 (or some other chosen value) under any conditions. These methods provide “strong” control against Type I error, in all conditions including a partially correct null hypothesis. Methods where total alpha can be proved not to exceed 0.05 except under certain defined conditions. Methods which rely on an omnibus test before proceeding to multiple comparisons. Typically these methods require a significant ANOVA/Tukey's range test before proceeding to multiple comparisons. These methods have “weak” control of Type I error. Empirical methods, which control the proportion of Type I errors adaptively, utilizing correlation and distribution characteristics of the observed data.

The advent of computerized resampling methods, such as bootstrapping and Monte Carlo simulations, has given rise to many techniques in the latter category. In some cases where exhaustive permutation resampling is performed, these tests provide exact, strong control of Type I error rates; in other cases, such as bootstrap sampling, they provide only approximate control. Multiple comparison procedures are commonly used in an analysis of variance after obtaining a significant omnibus test result, like the ANOVA F-test. The significant ANOVA result suggests rejecting the global null hypothesis H₀ that the means are the same across the groups being compared. Multiple comparison procedures are then used to determine which means differ. In a one-way ANOVA involving K group means, there are K(K−1)/2 pairwise comparisons.

Traditional methods for multiple comparisons adjustments focus on correcting for modest numbers of comparisons, often in an analysis of variance. A different set of techniques have been developed for “large-scale multiple testing”, in which thousands or even greater numbers of tests are performed. For example, in genomics, when using technologies such as microarrays, expression levels of tens of thousands of genes can be measured, and genotypes for millions of genetic markers can be measured. Particularly in the field of genetic association studies, there has been a serious problem with non-replication—a result being strongly statistically significant in one study but failing to be replicated in a follow-up study. Such non-replication can have many causes, but it is widely considered that failure to fully account for the consequences of making multiple comparisons is one of the causes.

In different branches of science, multiple testing is handled in different ways. It has been argued that if statistical tests are only performed when there is a strong basis for expecting the result to be true, multiple comparisons adjustments are not necessary It has also been argued that use of multiple testing corrections is an inefficient way to perform empirical research, since multiple testing adjustments control false positives at the potential expense of many morefalse negatives. On the other hand, it has been argued that advances in measurement and information technology have made it far easier to generate large datasets for exploratory analysis, often leading to the testing of large numbers of hypotheses with no prior basis for expecting many of the hypotheses to be true. In this situation, very high false positive rates are expected unless multiple comparisons adjustments are made.

For large-scale testing problems where the goal is to provide definitive results, the familywise error rate remains the most accepted parameter for ascribing significance levels to statistical tests. Alternatively, if a study is viewed as exploratory, or if significant results can be easily re-tested in an independent study, control of the false discovery rate (FDR)^{[} is often preferred. The FDR, defined as the expected proportion of false positives among all significant tests, allows researchers to identify a set of “candidate positives”, of which a high proportion are likely to be true. The false positives within the candidate set can then be identified in a follow-up study.

A basic question faced at the outset of analyzing a large set of testing results is whether there is evidence that any of the alternative hypotheses are true. One simple meta-test that can be applied when it is assumed that the tests are independent of each other is to use the Poisson distribution as a model for the number of significant results at a given level α that would be found when all null hypotheses are true. If the observed number of positives is substantially greater than what should be expected, this suggests that there are likely to be some true positives among the significant results. For example, if 1000 independent tests are performed, each at level α=0.05, we expect 50 significant tests to occur when all null hypotheses are true. Based on the Poisson distribution with mean 50, the probability of observing more than 61 significant tests is less than 0.05, so if we observe more than 61 significant results, it is very likely that some of them correspond to situations where the alternative hypothesis holds. A drawback of this approach is that it over-states the evidence that some of the alternative hypotheses are true when the test statistics are positively correlated, which commonly occurs in practice

Another common approach that can be used in situations where the test statistics can be standardized to Z-scores is to make a normal quantile plot of the test statistics. If the observed quantiles are markedly more dispersed than the normal quantiles, this suggests that some of the significant results may be true positives.

A comparison sort can be a type of sorting algorithm that only reads the list elements through a single abstract comparison operation (often a “less than or equal to” operator or a three-way comparison) that determines which of two elements should occur first in the final sorted list. The only requirement is that the operator obey two of the properties of a total order. :if a≦b and b≦c then a≦c (transitivity). for all a and b, either a≦b or b≦a (totalness or trichotomy). It is possible that both a≦b and b≦a; in this case either may come first in the sorted list. In a stable sort the input order determines the sorted order in this case. A metaphor for thinking about comparison sorts is that someone has a set of unlabeled weights and a balance scale Their goal is to line up the weights in order by their weight without any information except that obtained by placing two weights on the scale and seeing which one is heavier (or if they weigh the same).

Performance limits and advantages of different sorting techniques There are fundamental limits on the performance of comparison sorts. A comparison sort must have a lower bound of Ω(n log n) comparison operations, which is known as linearithmic time. This is a consequence of the limited information available through comparisons alone—or, to put it differently, of the vague algebraic structure of totally ordered sets. In this sense, mergesort, heapsort, and introsort are asymptotically optimal in terms of the number of comparisons they must perform, although this metric neglects other operations. The three non-comparison sorts above achieve O(n) performance by using operations other than comparisons, allowing them to sidestep this lower bound (assuming elements are constant-sized).

Note that comparison sorts may run faster on some lists; many adaptive sorts such as insertion sort run in O(n) time on an already-sorted or nearly-sorted list. The Ω(n log n) lower bound applies only to the case in which the input list can be in any possible order.

Also note that real-world measures of sorting speed may need to take into account the ability of some algorithms to optimally use relatively fast cached computer memory, or the application may benefit from sorting methods where sorted data begins to appear to the user quickly (and then user's speed of reading will be the limiting factor) as opposed to sorting methods where no output is available for display until the whole list is sorted.

Despite these limitations, comparison sorts offer the notable practical advantage that control over the comparison function allows sorting of many different datatypes and fine control over how the list is sorted.

Given a list of distinct numbers (we can assume this because this is a worst-case analysis), there are n factorial permutations exactly one of which is the list in sorted order. The sort algorithm must gain enough information from the comparisons to identify the correct permutation. If the algorithm always completes after at most f(n) steps, it cannot distinguish more than 2^{f(n)} cases because the keys are distinct and each comparison has only two possible outcomes. Therefore, 2^{f(n)}≧n!, or equivalently f(n)≧log₂(n!). From Stirling's approximation we know that log₂(n!) is Ω(n log₂ n). This provides the lower-bound part of the claim.

An identical upper bound follows from the existence of the algorithms that attain this bound in the worst case. The above argument provides an absolute, rather than only asymptotic lower bound on the number of comparisons, namely ┌log₂(n!)┐ comparisons. This lower bound is fairly good (it can be approached within a linear tolerance by a simple merge sort), but it is known to be inexact. For example, ┌log₂(13!┐=33, but the minimal number of comparisons to sort 13 elements has been proved to be 34. Determining the exact number of comparisons needed to sort a given number of entries is a computationally hard problem even for small n, and no simple formula for the solution is known.

Lower bound for the average number of comparisons. A similar bound applies to the average number of comparisons. Assuming that all keys are distinct, i.e. every comparison will give either a>b or a<b, and the input is a random permutation, chosen uniformly from the set of all possible permutations of n elements, it is impossible to determine which order the input is in with fewer than log₂(n!) comparisons on average.

This can be most easily seen using concepts from information theory. The Shannon entropy of such a random permutation is log₂(n!) bits. Since a comparison can give only two results, the maximum amount of information it provides is 1 bit. Therefore after k comparisons the remaining entropy of the permutation, given the results of those comparisons, is at least log₂(n!)−k bits on average. To perform the sort, complete information is needed, so the remaining entropy must be 0. It follows that k must be at least log₂(n!).

Note that this differs from the worst case argument given above, in that it does not allow rounding up to the nearest integer. For example, for n=3, the lower bound for the worst case is 3, the lower bound for the average case as shown above is approximately 2.58, while the highest lower bound for the average case is 8/3, approximately 2.67.

In the case that multiple items may have the same key, there is no obvious statistical interpretation for the term “average case”, so an argument like the above cannot be applied without making specific assumptions about the distribution of keys. Additional embodiments and methods of indexing and cataloguing techniques envisioned to be used as a component, alone, and/or in conjunction with elements of the Process are further contemplated.

Once a user entity completes and fully makes operational a user entity account, the information is indexed and catalogued as described above, with reference to the particular user entity. However, the information can also be indexed and catalogued in reference to other user entities. This indexing and cataloguing in reference to other user entities creates a necessary comparison of information to determine similarity.

At 408, a comparison of stored information is made, to determine if at least one indexed and catalogued user entity preference is different from, similar to or the same at least one user entity preference indexed and catalogued for at least one second user entity. For these purposes, comparisons can be made, for example, using a sorting algorithm. Sorting algorithms are an important part of managing data. Various sorting algorithms are contemplated, and can be executed using a variety of methods and coding languages and communication methods as described above with reference to FIG. 1. Each algorithm has particular strengths and weaknesses, however, any number of sorting algorithms can be used alone, individually, consequentially, or in some form of combination based on the type and content of information data to reviewed through. Comparison at 408 can be, but is not limited to, an active comparison instigated by a user entity, a passive comparison generated by a computing device, for example, the Social Network Manager 245 as illustrated in FIG. 2, or some combination thereof.

Most sorting algorithms work by comparing the data being sorted. In some cases, it may be desirable to sort a large chunk of data (for instance, a struct containing a name and address) based on only a portion of that data. The piece of data actually used to determine the sorted order is called the key.

Sorting algorithms are usually judged by their efficiency. In this case, efficiency refers to the algorithmic efficiency as the size of the input grows large and is generally based on the number of elements to sort. Most of the algorithms in use have an algorithmic efficiency of either O(n̂2) or O(n*log(n)). A few special case algorithms can sort certain data sets faster than O(n*log(n)). These algorithms are not based on comparing the items being sorted and rely on tricks. It has been shown that no key-comparison algorithm can perform better than O(n*log(n)).

Many algorithms that have the same efficiency do not have the same speed on the same input. First, algorithms must be judged based on their average case, best case, and worst case efficiency. Some algorithms, such as quick sort, perform exceptionally well for some inputs, but horribly for others. Other algorithms, such as merge sort, are unaffected by the order of input data. Even a modified version of bubble sort can finish in O(n) for the most favorable inputs.

A second factor is the “constant term”. As big-O notation abstracts away many of the details of a process, it is quite useful for looking at the big picture. But one thing that gets dropped out is the constant in front of the expression: for instance, O(c*n) is just O(n). In the real world, the constant, c, will vary across different algorithms. A well-implemented quicksort should have a much smaller constant multiplier than heap sort.

A second criterion for judging algorithms is their space requirement—do they require scratch space or can the array be sorted in place (without additional memory beyond a few variables)? Some algorithms never require extra space, whereas some are most easily understood when implemented with extra space (heap sort, for instance, can be done in place, but conceptually it is much easier to think of a separate heap). Space requirements may even depend on the data structure used (merge sort on arrays versus merge sort on linked lists, for instance). A third criterion is stability—does the sort preserve the order of keys with equal values.

One exemplary embodiment of a sorting algorithm is bubble sort. The bubble sort works by iterating down an array to be sorted from the first element to the last, comparing each pair of elements and switching their positions if necessary. This process is repeated as many times as necessary, until the array is sorted. Since the worst case scenario is that the array is in reverse order, and that the first element in sorted array is the last element in the starting array, the most exchanges that will be necessary is equal to the length of the array. Here is a simple example: Given an array 23154 a bubble sort would lead to the following sequence of partially sorted arrays: 21354, 21345, 12345. First the 1 and 3 would be compared and switched, then the 4 and 5. On the next pass, the 1 and 2 would switch, and the array would be in order.

Another exemplary embodiment of a sorting algorithm is known as a modified bubble sort, which can include a flag that is set if an exchange is made after an entire pass over the array. If no exchange is made, then it should be clear that the array is already in order because no two elements need to be switched. In that case, the sort should end. The new best case order for this algorithm is O(n), as if the array is already sorted, then no exchanges are made.

Selection sort is another exemplary embodiment of a sorting algorithm, and is the most conceptually simple of all the sorting algorithms. It can work by selecting the smallest (or largest, if you want to sort from big to small) element of the array and placing it at the head of the array. Then the process is repeated for the remainder of the array; the next largest element is selected and put into the next slot, and so on down the line. Because a selection sort looks at progressively smaller parts of the array each time (as it knows to ignore the front of the array because it is already in order), a selection sort is slightly faster than bubble sort, and can be better than a modified bubble sort.

Insertion sort is an additional exemplary embodiment of a sorting algorithm, and has the option of inserting each element of the array into its proper position, leaving progressively larger stretches of the array sorted. What this means in practice is that the sort iterates down an array, and the part of the array already covered is in order; then, the current element of the array is inserted into the proper position at the head of the array, and the rest of the elements are moved down, using the space just vacated by the element inserted as the final space. One example, includes, but is not limited to: for sorting the array the array 52314 First, 2 is inserted before 5, resulting in 25314 Then, 3 is inserted between 2 and 5, resulting in 23514 Next, one is inserted at the start, 12354 Finally, 4 is inserted between 3 and 5, 12345.

A further exemplary embodiment of a sorting algorithm can include heap sort, which is based on the heap data structure. The top element of the heap is always “next” in order (either the next highest or next lowest, in the case of numbers). There are two factors at work: the time it takes to create a heap by adding each element and the time it takes to remove all of the elements from a heap. Fortunately, we have a guarantee that adding a single element to and removing a single element from a heap both take O(log(n)) time. As noted above, each of these operations takes place once for each element in the input. Consequently, the algorithmic efficiency of a heap sort is O(n*log(n)), rather good indeed.

All exemplary embodiments of indexing, cataloguing, and sorting methods and calculation algorithms included in this detailed description herein are in no way to be limiting on the inventive concept. All elements described herein are for illustrative purposes only and are not intended to limit the indexing, cataloguing, and/or comparison methods contemplated within the scope and spirit of the present invention.

At 408, if the comparison is found to be different, the process ends at terminator 429. Different, in the context of the present invention can be defined, for example, by the type and/or combination of methods and content contemplated in the sorting algorithm used. As described above, embodiments and methods of calculation as contemplated for use as whole or in part of the sorting algorithm are also contemplated.

However, if the comparison at 408 is determined to be the same, a geographical location search is conducted at 410 to determine the location of the user entity device of the user entity whose user entity preference has been found to be the same. Same, in the context of the present invention can be defined, for example, by the type and/or combination of methods and content contemplated in the sorting algorithm used.

The geographical location search conducted at 410 can include a determination of geographic position contemplated using any number of location methods, processes, applications, programs, and/or algorithms. Multiple embodiments of geolocation, geographical location software and applications and mapping elements are considered. One exemplary system for determining a geographic location includes, but is not limited to Global Positioning System (GPS), a space-based satellite navigation system that provides location and time information in all weather conditions, anywhere on or near the Earth where there is an unobstructed line of sight to three or more GPS satellites. The system provides critical capabilities to military, civil and commercial users around the world. It is maintained by the United States government and is freely accessible to anyone with a GPS receiver. Advances in technology and new demands on the existing system have now led to efforts to modernize the GPS system and implement the next generation of GPS III satellites and Next Generation Operational Control System (OCX). In addition to GPS, other exemplary systems in use or under development include the Russian Global Navigation Satellite System (GLONASS), developed contemporaneously with GPS, but suffered from incomplete coverage of the globe until the mid-2000s. There are also the planned European Union Galileo positioning system, Chinese Compass navigation system, and Indian Regional Navigational Satellite System. One component of a system in which process 400 would be executed, specifically geographical location search 410, would require the use of a GPS or other locational information receiver. GPS or locations receivers come in a variety of formats, for example, from devices integrated into cars, phones, and watches, to dedicated devices. A majority of user entity devices 130, 200 as described and detailed in FIGS. 1 and 2 are contemplated to have elements of location receivers as integrated into, attachable to, and/or functioning as part of the devices.

In general, GPS receivers are composed of an antenna, tuned to the frequencies transmitted by the satellites, receiver-processors, and a highly stable clock (for example, a crystal oscillator). They may also include a display for providing location and speed information to the user. A receiver is often described by its number of channels: this signifies how many satellites it can monitor simultaneously. GPS receivers may include an input for differential corrections, using the RTCM SC-104 format. This is typically in the form of an RS-232 port at 4,800 bit/s speed. Data is actually sent at a much lower rate, which limits the accuracy of the signal sent using RTCM. Receivers with internal DGPS receivers can outperform those using external RTCM data. units commonly include Wide Area Augmentation System (WAAS) receivers.

Many GPS receivers can relay position data to a PC or other device using the NMEA 0183 protocol. Although this protocol is officially defined by the National Marine Electronics Association (NMEA),^{[} references to this protocol have been compiled from public records, allowing open source tools like gpsd to read the protocol without violating intellectual property laws. Other proprietary protocols exist as well, such as the SiRF and MTK protocols. Receivers can interface with other devices using methods including a serial connection, USB, or Bluetooth. Additional embodiments of receivers and/or locational element devices, geolocation, geographical location software and applications and mapping elements are further contemplated.

If at 408, the comparison is found to be similar, and additional step of ranking analysis is completed at 412, prior to geographic location search at 410. Similar, as envisioned by Process 400 and the embodiments and methods contemplated to practice the invention within the scope and spirit of the description provided herein, is defined as not the same and not different. It is contemplated in this one exemplary embodiment of the present invention that all comparisons at 408 may result in a designation of similar resulting in a ranking analysis having to be performed at 412.

As described above, the ranking analysis which occurs at 412 are through use of a ranking method as selected by a user entity. These methods can include, but are not limited to, a user-defined method of rank, wherein the user manually determines the rank without input from a the social networking services; a services-assisted method wherein a user entity is recommended a rank based on similarly situated user entities; a random ranking method, or any other functionally necessary ranking method. Additional methods and embodiments depicting ranking methods are further contemplated.

Once a geographical location is searched and determined at 410, a comparison of geographic locations is determined at 416. The comparison made at 416 can be similar in functionality to the comparison made at 408.

A further aspect of the geographic comparison at 416 can include authentication and review of privacy-publicity settings for each of the at least one user entities determined to have both similar and/or same user entity preference designations and a geographical location proximity that is in accordance with user entity preferences. Authentication of user entities and their user entity devices can occur through various methods and embodiments as contemplated to be used alone, in conjunction or integrated into the system, methods, and processes which are part of the inventive concept.

Authentication can be defined as the act of confirming the truth of an attribute of a datum or entity. This might involve confirming the identity of a person or software program, tracing the origins of an artifact, or ensuring that a product is what its packaging and labeling claims to be. Authentication often involves verifying the validity of at least one form of identification.

In one embodiment, a secure key storage device can be used for authentication in consumer electronics, network authentication, license management, supply chain management, and any other system or process that requires an authentication element. Generally, for example, the device to be authenticated can have some sort of wireless or wired digital connection to either a host system or a network. The component being authenticated need not be electronic in nature as an authentication chip can be mechanically attached and read through a connector to the host e.g. an authenticated ink tank for use with a printer. For products and services that these secure coprocessors can be applied to, they can offer a solution that can be much more difficult to counterfeit than most other options while at the same time being more easily verified.

The process of authorization is distinct from that of authentication. Whereas authentication is the process of verifying that “you are who you say you are”, authorization is the process of verifying that “you are permitted to do what you are trying to do”. Authorization thus presupposes authentication. For example, a client showing proper identification credentials to a bank teller is asking to be authenticated that he really is the one whose identification he is showing. A client whose authentication request is approved becomes authorized to access the accounts of that account holder, but no others. However note that if a stranger tries to access someone else's account with his own identification credentials, the stranger's identification credentials will still be successfully authenticated because they are genuine and not counterfeit, however the stranger will not be successfully authorized to access the account, as the stranger's identification credentials had not been previously set to be eligible to access the account, even if valid (i.e. authentic).

Similarly when someone tries to log on a computer, they are usually first requested to identify themselves with a login name and support that with a password. Afterwards, this combination is checked against an existing login-password validity record to check if the combination is authentic. If so, the user becomes authenticated (i.e. the identification he supplied in step 1 is valid, or authentic). Finally, a set of pre-defined permissions and restrictions for that particular login name is assigned to this user, which completes the final step, authorization. Even though authorization cannot occur without authentication, the former term is sometimes used to mean the combination of both.

One exemplary use of authentication and authorization is access control. In one embodiment of the present process, a user entity device is contemplated to be used only by those authorized, and attempts to detect and exclude the unauthorized are considered. Access to a user entity device should then, generally, be controlled by insisting on an authentication procedure to establish with some degree of confidence the identity of the user, granting privileges established for that identity. Further exemplary examples of access control involving authentication include, but are not limited to, using a captcha or other recognition software application as a means of asserting that a user is a human being and not a computer program, by using One Time Password (OTP), received on a tele-network enabled device like mobile phone, as an authentication password/PIN, A computer program using a blind credential to authenticate to another program, using a confirmation E-mail to verify ownership of an e-mail address.

In additional exemplary embodiments of the present process, ease of access may be balanced against the strictness of access checks. In one example, a credit card network infrastructure may be modeled but where the system does or does not require a personal identification number for authentication of the claimed identity.

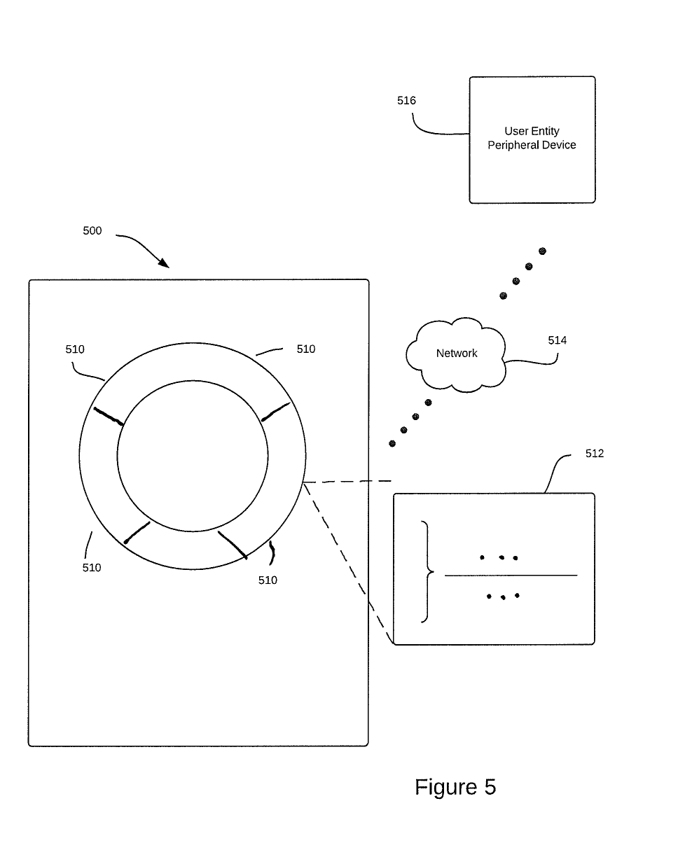

At 418 and 420, a user is notified of the authenticated similarities and geographic location. Notification at these elements can include a visual display, an audio display, a combination of audio and visual display. As display will occur through one of a user entity device and/or a user entity peripheral device which is described in more detail in reference to User Entity Peripheral Device 516 in FIG. 5. Display methods will occur according to the options and functionalities of the device itself. For example, a peripheral device may include a button that lights up and/or makes a sound. A mobile device, for example, a mobile phone, can vibrate and display a written message. Additional embodiments and methods of display and notification are further contemplated.

Once authentication and notification methods are executed at 418, 420, a determination is made whether the comparison at 408 should be continued at 422 or ended at 429. A user entity has the option to actively continue or passively continue as described above, through active participation through data transmission and/or communication with another user entity or through deciding on resetting and/or changing user entity preferences and settings at 424 or not. If a user actively chooses to reset or change settings at 424, a user is directed to begin the process over at 401. If a user passively decides to continue at 422 or actively chooses to continue at 422 but does not want to change user entity preferences and settings at 424, the comparison of user entity preferences are re-performed at 408, as described above. Additional embodiments of continuing at 422 are contemplated as part of the inventive concept.

FIG. 5 illustrates one exemplary embodiment of a display interface 500 in which the inventive concept can be practiced. Display interface 500 is contemplated to be displayed and/or operated using user entity devices and network devices as illustrated in FIGS. 1-3. Non-transitory computer readable instructions executed on such devices are contemplated to executed to operate such exemplary embodiments of display interface 500. Display interface 500, as illustrated, depicts a graphical depiction of at least one user entity preference 510. As shown in FIG. 5, four user entity preferences 510 are illustrated. However, any number of user entity preferences 510 are contemplated. For example, a user entity can decide to make public only one preference and/or search setting. In this case, user entity preference 510 would be depicted alone and/or in combination with any of a number of the visual elements as provided by a creator or determined to be used by a user entity.

An exemplary user entity preference 510 can be created and/or chosen, determined, and/or appointed as shown in exemplary preference determination block 512, which is a selectable element as provided through the graphical display and/or user interface. Preference determination block 512 can include any selectable and/or enterable element as functionally necessary to include as part of a user identity a user entity preference 510, which has the option of being displayed as part of display interface 500.

In one exemplary example of preference determination block 512, a user entity is asked a number of informational questions and provided locations in which to type and/or otherwise enter answers to the questions. The answers can then be analyzed, indexed and catalogued, for example, using any one of the exemplary embodiments of methods described in more detail with reference to FIG. 4. Additional embodiments of preference determination block 512 are contemplated, including, but not limited to, any selection and/or data entry method that is functionally necessary to collect user entity preferences in a manner that can be analyzed, indexed and catalogued.

Data relating to sending and/or receiving information, for example, as described above in more detail in FIGS. 1-3, can be communicated over network 514. Network 514 can a wired network, for example, comparable to network 110 as described in reference to FIG. 1; can be a wireless network, for example, comparable to wireless network 120 as described in reference to FIG. 1; or some combination of a wired and/or wireless network.

User entity peripheral device 516 or peripheral network accessory device can be any user personal electronic device, for example, virtually any computing and/or receiving device capable of receiving communicating over a network, including receiving social networking information, performing various online activities, including receiving data from other user entity devices, user entity peripherals and similar. The set of such devices that can be used for user entity peripheral devices 516 include devices that typically connect using a wired or wireless communications mediums, such as, for example, microprocessor-based or programmable consumer electronics, and the like. In one embodiment, at least some of the user entity peripheral devices 140 can operate over wired and/or wireless networks. These devices can include, for example, but are not limited to, mobile phones, smartphones, display pagers, Radio Frequency (RF) devices, Infrared (IR) devices, Near Frequency Communication (NFC) devices, Personal Digital Assistants (PDAs), handheld computers, tablets, laptop computers, wearable computers, general computer peripheral accessories, integrated devices combining one or more of the preceding devices, and the like. User entity peripheral devices 516 can also include virtually device usable as a television device, as many newer models of these devices include a capability to access and/or otherwise communicate over a network, for example, such as network 110 and/or wireless network 120 as described in FIG. 1. Communications to these devices can occur using networks and/or methods as described above.

User entity peripheral devices 516 generally can include a processor and configured to receive at least one data element from the one or more user entity devices over a network, and to display to a user entity the at least one data element through a visual notification or an audio notification. For example, displaying can occur when the at least one data element is a similar at least one data element to an at least one data element of an at least one second user entity that is in a geographical proximity of the user entity. Displaying, as described herein, can include a visual depiction, for example, a light turning on, an image and/or text being displayed. Displaying can also include, but is not limited to, an audio notification, for example, a buzzer sounding or a vibration resulting in sensory notification. Furthermore, a number of embodiments are contemplated where displaying results in at least one combination of visual and/or audio display.

Additional methods, aspects and elements of the present inventive concept are contemplated in use in conjunction with individually or in any combination thereof which will create a reasonably functional method, system and device to be of use as a social networking interface. Methods of use are also contemplated using all optional aspects and embodiments as described above, individually or in combination thereof.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

Therefore, I claim:

1. A network device, comprising:
a transceiver to send and receive data over a network; and
a processor that is operative on the received data to perform actions, comprising:
receiving at least one of a user entity preference, wherein said user preference is indexed, catalogued and stored with reference to a user entity;
comparing the at least one user entity preference with a plurality of other user entity preferences which are indexed, catalogued, and stored with reference to at least one second user entity; and
notifying and displaying to the user entity a shared at least one user entity preference with the at least one second user entity.

2. The network device of claim 1, wherein the actions further comprise:
evaluating the received at least one user entity preference to identify a user entity-defined selection for comparing the at least one user entity preference with the plurality of other user entity preference.

3. The network device of claim 1, wherein the actions further comprise:
receiving the at least one of a user entity preference further comprises receiving a geographical location marker for the user entity; and
comparing the at least one user entity preference with the plurality of other user entity preferences further comprises comparing with the geographical location markers received for the at least one second user entity.

4. The network device of claim 1, wherein the actions further comprise:
receiving the at least one of a user entity preference further comprises receiving a geographical location marker for the user entity;
comparing the at least one user entity preference with the plurality of other user entity preferences further comprises comparing with the geographical location markers received for the at least one second user entity; and
notifying and displaying to the user entity a shared at least one user entity preference with the at least one second user entity further comprises notifying and displaying a geographical proximity of the at least one second user entity to the user entity.

5. The network device of claim 1, wherein the actions further comprise:
providing the user entity with one or more interface display screens usable to enable the user entity to select various user entity preferences, wherein selecting various user entity preferences further comprises allowing the user entity to:
rank an importance of the user entity preferences, wherein the importance rank factors into the comparison of user entity preferences with the plurality of other user entity preferences; and
select a level of privacy accorded to each user entity preference, wherein the level of privacy determines whether or not the at least second user entity receives notification of shared user entity preference.

6. The network device of claim 1, wherein the actions further comprise:
notifying and displaying to the user entity a shared at least one user entity preference with the at least one second user entity further comprises connecting to a peripheral network accessory which displays and/or notifies to either and/or both the user entity and the at least one second user entity a visual and/or sensory notification of geographical proximity of the user entity and/or the at least one second user entity.

7. A system, comprising:
one or more user entity devices; and
a network device comprising a processor and configured to communicate with the one or more user entity devices over a network, and to perform actions comprising:
receiving, by the network device from a first user entity device in the one or more user entity devices, at least one of a user entity preference, wherein said user preference is indexed, catalogued and stored with reference to a user entity;
comparing, by the network device, the at least one user entity preference with a plurality of other user entity preferences which are indexed, catalogued, and stored with reference to at least one second user entity; and
notifying and displaying, by the network device, the user entity a shared at least one user entity preference with the at least one second user entity.

8. The system of claim 6, wherein the network device performs actions further comprising:
evaluating the received at least one user entity preference to identify a user entity-defined selection for comparing the at least one user entity preference with the plurality of other user entity preference.

9. The system of claim 6, wherein the network device performs actions further comprising:
receiving the at least one of a user entity preference further comprises receiving a geographical location marker for the user entity; and
comparing the at least one user entity preference with the plurality of other user entity preferences further comprises comparing with the geographical location markers received for the at least one second user entity.

10. The system of claim 6, wherein the network device performs actions further comprising:
receiving the at least one of a user entity preference further comprises receiving a geographical location marker for the user entity;
comparing the at least one user entity preference with the plurality of other user entity preferences further comprises comparing with the geographical location markers received for the at least one second user entity; and
notifying and displaying to the user entity a shared at least one user entity preference with the at least one second user entity further comprises notifying and displaying a geographical proximity of the at least one second user entity to the user entity.

11. The system of claim 6, wherein the network device performs actions further comprising:
providing the user entity with one or more interface display screens usable to enable the user entity to select various user entity preferences, wherein selecting various user entity preferences further comprises allowing the user entity to:
rank an importance of the user entity preferences, wherein the importance rank factors into the comparison of user entity preferences with the plurality of other user entity preferences; and
select a level of privacy accorded to each user entity preference, wherein the level of privacy determines whether or not the at least second user entity receives notification of shared user entity preference.

12. The system of claim 6, wherein the network device performs actions further comprising:
notifying and displaying to the user entity a shared at least one user entity preference with the at least one second user entity further comprises connecting to a peripheral network accessory which displays and/or notifies to either and/or both the user entity and the at least one second user entity a visual and/or sensory notification of geographical proximity of the user entity and/or the at least one second user entity.

13. A non-transitory computer readable storage medium having computer-executable instructions, the computer-executable instructions when installed onto a computing device enable the computing device to perform actions, comprising:
receiving at least one of a user entity preference, wherein said user preference is indexed, catalogued and stored with reference to a user entity;
comparing the at least one user entity preference with a plurality of other user entity preferences which are indexed, catalogued, and stored with reference to at least one second user entity; and
notifying and displaying to the user entity a shared at least one user entity preference with the at least one second user entity.

14. The non-transitory computer readable storage medium device of claim 11, wherein the actions further comprise:
evaluating the received at least one user entity preference to identify a user entity-defined selection for comparing the at least one user entity preference with the plurality of other user entity preference.

15. The non-transitory computer readable storage medium device of claim 11, wherein the actions further comprise:
receiving the at least one of a user entity preference further comprises receiving a geographical location marker for the user entity; and
comparing the at least one user entity preference with the plurality of other user entity preferences further comprises comparing with the geographical location markers received for the at least one second user entity.

16. The non-transitory computer readable storage medium device of claim 11, wherein the actions further comprise:
receiving the at least one of a user entity preference further comprises receiving a geographical location marker for the user entity;
comparing the at least one user entity preference with the plurality of other user entity preferences further comprises comparing with the geographical location markers received for the at least one second user entity; and
notifying and displaying to the user entity a shared at least one user entity preference with the at least one second user entity further comprises notifying and displaying a geographical proximity of the at least one second user entity to the user entity.

17. The non-transitory computer readable storage medium device of claim 11, wherein the actions further comprise:
providing the user entity with one or more interface display screens usable to enable the user entity to select various user entity preferences, wherein selecting various user entity preferences further comprises allowing the user entity to:
rank an importance of the user entity preferences, wherein the importance rank factors into the comparison of user entity preferences with the plurality of other user entity preferences; and
select a level of privacy accorded to each user entity preference, wherein the level of privacy determines whether or not the at least second user entity receives notification of shared user entity preference.

18. The non-transitory computer readable storage medium device of claim 11, wherein the actions further comprise:
notifying and displaying to the user entity a shared at least one user entity preference with the at least one second user entity further comprises connecting to a peripheral network accessory which displays and/or notifies to either and/or both the user entity and the at least one second user entity a visual and/or sensory notification of geographical proximity of the user entity and/or the at least one second user entity.

19. A system, comprising:
one or more user entity devices; and
a user entity peripheral device comprising a processor and configured to receive at least one data element from the one or more user entity devices over a network, and to perform actions comprising:
displaying to a user entity the at least one data element through a visual notification or an audio notification;
wherein displaying occurs when the at least one data element is a similar at least one data element to an at least one data element of an at least one second user entity that is in a geographical proximity of the user entity.
